(19) United States
(12) Patent Application Publication
(10) Pub. No.: US 2026/0139123 A1
(43) Pub. Date: May 21, 2026

(54) SYSTEMS AND METHODS FOR REDISPERSION OF NANOCELLULOSE ELEMENTS

(71) Applicant: Soane Materials LLC, Miami, FL (US)

(72) Inventors: Lauren G. DUKE, Miami, FL (US); Sydney Greenough HIGGINS, Miami, FL (US); David S. SOANE, Coral Gables, FL (US)

(21) Appl. No.: 19/392,269

(22) Filed: Nov. 18, 2025

Related U.S. Application Data
(60) Provisional application No. 63/722,012, filed on Nov. 18, 2024.
(60) Provisional application No. 63/772,057, filed on Mar. 14, 2025.

(51) Int. Cl. C08L 1/02; C08J 3/21; C08J 5/18; C08K 5/053

(52) U.S. Cl. CPC C08L 1/02; C08J 3/21; C08J 5/18; C08K 5/053; C08J 2301/02; C08J 2401/28; C08L 2205/025; C08L 2205/03; C08L 2205/16

(57) ABSTRACT

Described are methods of preparing a solid or semisolid material comprising nanocellulose (NC) elements, wherein the solid or semisolid material retains at least about 5 wt % water. The methods can comprise the steps of providing a liquid formulation comprising a suspension of nanocellulose (NC) elements in a liquid medium, and at least one drying/dispersal additive, and partially drying the liquid formulation, thereby producing the solid or semisolid material. The present invention further provides solid or semisolid materials formed using the described methods.

### RELATED APPLICATIONS

This application claims the benefit of U.S. Provisional Application No. 63/722,012 filed Nov. 18, 2024 and U.S. Provisional Application No. 63/772,057 filed Mar. 14, 2025. The entire contents of the above-referenced applications are incorporated by reference herein.

### FIELD OF THE INVENTION

This application relates to nanocellulosic materials.

### BACKGROUND OF THE INVENTION

Cellulose, the main building block for wood and plant fibers, is an abundant resource for the paper, textile, and chemical industries. It is a high molecular weight homopolymer of 1,4-linked β-D-glucopyranose units in which each unit is rotated 180° with respect to adjacent units. The monomeric glucopyranose units each contain three hydroxyl groups, which present themselves on alternating opposite sides of the polymer because of the rotational pattern of their linear arrangement within the polymer. The alternating orientation of the hydroxyl groups along the length of the cellulose molecule allows one strand of cellulose to form hydrogen bonds readily with adjacent strands of the polymer. These hydrogen bonds permit the formation of multistrand composites that are stable, strong, and tightly cohesive.

In biological systems, individual polymeric cellulose molecules form larger units with similar molecules. Biosynthesis within a plant can allow about thirty-six individual molecules to be bound together compactly, thereby forming the most basic building blocks of the plant's cell wall. These building blocks are called elementary fibrils (also termed microfibrils). The elementary fibrils, formed during the biosynthesis of cellulose in the biological entity, are about 5 nm in diameter and can be several micrometers in length. Each elementary fibril is a flexible elongated strand comprised of crystalline regions of cellulose interspersed with disordered amorphous domains of cellulose. The crystalline regions are segments of cellulose chains that have been rigidly stabilized by a strong intersecting network of hydrogen bonds; the amorphous regions, while still bound by hydrogen bonds, are more flexible. These elementary fibrils (microfibrils) are packed together in biological systems to form larger units called microfibrillated cellulose, which have diameters ranging from about 20-50 nm. In biosystems, the microfibrillated cellulose units are aggregated, linked via hemicellulosic moieties, and embedded in a pectin matrix to form the visible cellulose fibers found in plant cell walls.

The structures of elementary cellulose fibrils and microfibrillated cellulose permit two discrete cellulose morphologies to be extracted from the plant-derived cellulosic raw materials. Crystalline cellulose can be extracted in particulate form, yielding products that are termed cellulose nanocrystals or cellulose microcrystals, depending on the size of the particles. Cellulose can also be extracted as fibers, yielding products that are termed cellulose nanofibers or cellulose microfibers, depending on the size of the fibers. Cellulose crystals and cellulose micro/nano fibers are extracted by different techniques, yielding different morphologies with different properties. The two fibrous materials, cellulose nanofibers and cellulose microfibers, are extracted from plant matter by different techniques from each other, so that their morphologies and properties are different. Cellulose nanofibers and cellulose microfibers can be distinguished from each other based on their size and shape: cellulose nanofibers (CNF, also known as “nanofibrillated cellulose” or “NFCs”) are much smaller in diameter than cellulose microfibers (CMF, also known as “microfibrillated cellulose” or “MFCs”) and can be straight and rod-like, while CMF are larger in diameter, more flexible in appearance and can be irregular in shape. While the literature cites a range of dimensions for CNF and for CMF, CNF fibers are nanoscale (for example, having a diameter between 4-20 nm), while CMF can be much larger still: CMF fibers typically still have diameters in the nano-range, for example 20-100 nm or larger.

In more detail, CMF fibers are produced by mechanical treatment of cellulosic feedstock, with or without chemical or enzymatic pre-treatment. CMF fibers are elongated with a high aspect ratio, containing crystalline and amorphous regions like native cellulose, and capable of forming a three-dimensional network. The size distribution of CMF fibers in a fiber population is wide, with smaller, nanoscale fibers interspersed in the CMF network with larger fibers. By contrast, for CNF fibers, different processing methods are involved to produce populations of individual fibrils with a narrow size distribution within the population. The dimensions in the CNF material are more consistently nanoscale, as compared to CMF fiber populations. As used herein, all three species (crystalline cellulose, CNF, and CMF) shall be included in the umbrella term “nanocelluloses” or nanocellulose elements (NCEs).

Nanocellulose (NC) materials hold immense promise for commercial applications, thanks to their biodegradable nature, low density, abundant source materials, and high mechanical performance. However, although the nano-size geometry and hydrophilic nature of these cellulosic materials offer opportunities, these features also present challenges. A number of applications have been developed that exploit NC's geometry and hydrophilicity. As an example, certain nanocelluloses can be dry blended with inorganic powders, including plaster and cement, to deliver mechanical fortification to structures upon hydration and curing. However, because they are hydrophilic, NC materials require modification so that they can be used in hydrophobic environments. Even in hydrophilic environments, or within a composite that uses the NC as a hydrophilic component, satisfactory NC dispersion can be difficult, limiting the usefulness of NC elements in many applications. Furthermore, limitations imposed by NC drying and dispersion techniques limit the usefulness of these materials for commercial applications.

NCs are usually produced by a series of mechanical and/or chemical procedures performed in an aqueous medium, whereby the aqueous suspension loosens cellulose's interfibrillar hydrogen bonding to facilitate delamination, resulting in the formation of NC derivatives having more useful degrees of polymerization and crystallinity and having higher aspect ratios. Typically, the NC materials are dispersed in the aqueous medium at a low concentration (<5 wt %) because their high water-absorption capacity cause them to form a highly viscous suspensions even at low solid concentrations, due to the entangling of the high-aspect-ratio NC elements.

However, these aqueous suspensions of NCs are difficult to manage and expensive to transport. Therefore, drying technologies have been devised to convert the NC suspension into a dry powder form. However, drying the NC suspension using conventional techniques (for example, evaporating the water at high temperatures) promotes the formation of aggregates (“aggregation”) due to the interaction of hydroxyl groups on the surface of the cellulose molecules, and the formation of hydrogen bonds. This aggregation process resulting from conventional drying, also called hornification, is characterized by irreversible or only partially reversible bonding between the hydroxyl groups on the NC particles or fibers.

The twin challenges of (a) NC drying from the aqueous media in which the NC is suspended and (b) redispersion of the dried NC is caused by two factors: (1) the propensity of cellulose polymers to form hydrogen bonds with one another, adhering adjacent cellulosic elements into irreversible aggregates (i.e., an assemblage of particles durably attached to each other, resisting redispersion in a suspension); and (2) the huge surface area (per unit weight) associated with the size and morphology of the NCE, greatly exacerbating adhesion due to hydrogen bonding.

While low-cost and effective drying and redispersion of NCE-containing suspensions have been accomplished using the techniques set forth in U.S. patent application Ser. No. 17/834,521 (“the '521 Application,” corresponding to US Patent App. Publication No. 20220412010, the contents of which are incorporated by reference herein), improvements are desirable so that these techniques can be performed efficiently using the equipment typically available for preparing NCE formulations. Available mixing equipment varies between product manufacturers who are using NCEs in their products. Those with high shear mixing may redisperse the NCE sheets with lower additive loading in a short mixing time whereas those with low shear mixing will require long mixing times and/or higher additive loading in their redispersible sheets.

A need therefore remains in the art to develop a cost-effective form of redispersible NCEs that can achieve full fiber unlocking under the same low shear mixing conditions and mixing time used by NCE customers today. A further need exists to create a viable redispersible NCE product that can be used as a raw material by manufacturers, undergoing complete redispersion when reconstituted in water, but without requirements for high loading concentrations of additives, high energy input, or prolonged manufacturing time. Advantageously, the techniques for producing such a redispersible NCE product would be suitable for commercial implementation, at low cost, without excessive energy requirements, and without need for specialized equipment.

### SUMMARY OF THE INVENTION

Disclosed herein, in embodiments, are methods of preparing a solid or semisolid material comprising redispersible nanocellulose (NC) elements, wherein the solid or semisolid material retains at least about 5 wt % water, comprising providing a liquid formulation comprising a suspension of nanocellulose (NC) elements in a liquid medium, and at least one drying/dispersal additive, wherein the drying/dispersal additive is selected from the group consisting of temperature-responsive polymers, small molecule additives in volatile systems, and blocking agents, and partially drying the liquid formulation, thereby producing the solid or semisolid material.

In embodiments, the solid or semisolid material retains an amount of water between a lower limit of about 5 wt % water and an upper limit of about 10 wt % water. In embodiments, the solid or semisolid material retains an amount of water between the lower limit of about 40 wt % and the upper limit of about 70 wt % water. In embodiments, the NC elements comprise cellulose nanofibers or cellulose microfibers. In embodiments, the at least one drying/dispersal additive is a temperature-responsive polymer, which can be a lower critical solution temperature (LCST) polymer or a short-chain oligomer derived from a LCST polymer. In embodiments, the LCST polymer is selected from the group consisting of methyl cellulose, carboxymethyl cellulose, sodium carboxymethyl cellulose, hydroxylethyl cellulose, hydroxypropyl cellulose, hydroxypropylmethyl cellulose, ethylhydroxyethyl cellulose, polyvinylcaprolactam, poly(methyl vinyl ether), poly(N-isopropylacrylamide), poly(N,N-diethylacrylamide), poly(ethylene oxide) and poly(propylene oxide) block copolymer, and elastin poly(pentapeptide), or a combination of any of thereof. In embodiments, the liquid formulation further comprises a second drying/dispersal additive selected from the group consisting of temperature-responsive polymers, small molecule additives in volatile systems, and blocking agents. In embodiments, the second drying/dispersal additive is a blocking agent, which is xylitol or sorbitol, and the LCST polymer is HPMC. In embodiments, the NC elements comprise cellulose nanofibers, and a ratio of the cellulose nanofibers, the HPMC and the xylitol or sorbitol falls within a range from about 38:1:1 NFC:HPMC:(xylitol or sorbitol) to about 8:1:1 NFC:HPMC:(xylitol or sorbitol). In additional embodiments, the drying/dispersal additive is a small molecule additive in a volatile system. In embodiments, the drying/dispersal additive is a blocking agent, which can be a humectant, or which can comprise pulp fibers.

In embodiments, the step of partial drying comprises heating the liquid formulation to a maximum temperature of less than 150° C. In embodiments, the step of partial drying comprises heating the liquid formulation to a temperature between about 60° C. and about 140° C. In embodiments, the step of partial drying comprises heating the liquid formulation to the maximum temperature between about 140° C. and about 250° C. In certain embodiments, the step of partial drying comprises a thermal drying method selected from the group consisting of heat pressing, continuous belt drying, drum drying, batch drying in an oven, the use of a heated mix chamber, and cylinder drying. In embodiments, the step of partial drying is achieved through the use of at least two thermal drying methods, which can be applied sequentially. In embodiments, the step of partial drying is achieved through use of a mechanical drying method selected from the group of vacuum dewatering, centrifugal dewatering, and mechanical pressing. In embodiments, the step of partial drying is achieved through use of at least two mechanical drying methods, which can be applied sequentially. The step of partial drying can be achieved through the use of the thermal drying method and the mechanical drying method. In certain embodiments, the step of partial drying comprises a substep of spreading the liquid formulation in a thin sheet and exposing the thin sheet to heat on one or both sides.

Further disclosed herein, in embodiments, is a solid or semi-solid material comprising a population of redispersible NC elements embedded within the material in a preselected concentration and comprising an amount at least one drying/dispersal additive and optionally comprising an amount of an additional additive or adjunct, wherein the solid or semi-solid material has a water content of at least about 5 wt %, and wherein the redispersibility of the solid or semi-solid material is greater than the redispersibility of a control solid material having a water content of less than about 5 wt %, and wherein the control solid material comprises a same population of redispersible NC elements at a same concentration and a same amount of the at least one drying/dispersal additive, and optionally comprises the same amount of the additional additive or adjunct. In embodiments, the solid or semi-solid material has a water content of at least between 5 wt % and 10 wt %, and the control solid material has a control water content less than the water content of the solid or semi-solid material. In embodiments, the redispersible NC elements comprise at least one of nanofibrillated cellulose and microfibrillated cellulose. In certain embodiments, the material is formed as a sheet.

### DETAILED DESCRIPTION OF THE INVENTION

### 1. Constituents of Redispersible Nanocellular Materials

It is understood that NC materials suitable for treatment with the systems and methods disclosed herein can be derived from all types of cellulosic raw materials, in particular plant-derived cellulosic raw materials, which can also be termed lignocellulosic materials. Lignocellulosic materials are formed of cellulose polymers as described above bound with varying amounts of lignin. Lignocellulosic materials can include virgin biomass, as is found in naturally occurring plants like trees, bushes, and grass. Lignocellulosic materials can include waste materials from consumption or from industries such as agriculture (e.g., corn stover and corncobs, sugarcane bagasse, straw, oil palm empty fruit bunch, pineapple leaf, apple stem, coir fiber, mulberry bark, rice hulls, bean hulls, soybean hulls (or “soyhulls”), cotton linters, blue agave waste, North African glass, banana pseudo stem residue, groundnut shells, pistachio nut shells, grape pomace, shea nut shell, passion fruit peels, fique fiber waste, sago seed shells, kelp waste, juncus plant stems, and the like), or forestry (saw mill and paper mill discards). Lignocellulosic materials can include specialty-purpose crops such as switchgrass and elephant grass cultivated for uses such as biofuels, capable of multiple harvests. Plants having use as lignocellulosic materials can be woody (such as trees, with firm stems, and with multiyear growth cycles) or non-woody, having weak stems and annual or limited multiyear growth cycles. Non-woody plants are particularly advantageous, typically possessing low amounts of lignin relative to the amount of cellulose they contain. As would be understood by those of skill in the art, different techniques are available for processing the various lignocellulosic materials to extract NC materials therefrom.

Disclosed herein, in embodiments, are additives that can be used for inhibiting or disrupting the hydrogen bonding of NC materials at elevated temperatures (for example, during drying), while retaining high intrinsic hydrophilicity, thus allowing facile redispersion in aqueous media. The formulations and methods disclosed herein include several different categories of additives (termed “drying/dispersal additives”): (1) certain temperature-responsive polymers that can introduce spacing between NC particles or fibers (collectively, “NC elements”) during drying, thus preventing their clumping; (2) certain volatile small molecules that can create space between NC elements during drying; and (3) certain nonvolatile small or large molecules that hinder hydrogen bonding between or among NC elements during drying. All of these materials act to disrupt hydrogen bonding at elevated temperatures or under other circumstances, while creating gaps between or among the NC elements with further drying that will permit subsequent redispersion.

As used herein, the term “drying” for an initial suspension of NC elements (termed the “initial NC suspension,” understood to be the suspension containing the NC elements that is initially produced during the defibrillation processes, as exemplified in the description that follows) refers to the application of heat and/or any other dewatering technology to the initial NC suspension that results in a decrease in the water content of the initial NC suspension so that the initial NC suspension is converted to a solid or semi-solid material comprising the NC elements that were present in the initial NC suspension. This dried solid or semi-solid material can be referred to as the “dried NC material.”

The present invention encompasses a technique of drying (termed partial drying or partial dewatering) a redispersible-NCE-containing formulation that yields a solid or semi-solid material that retains a certain amount of moisture (e.g., water). Ranges for the amounts of moisture in selected embodiments are described with reference to the following parameters: In embodiments, ranges of moisture (e.g., water) found in the material can cover embodiments characterized by lower limits such as at least about 5 wt % moisture (e.g., 5 wt % water), at least about 10 wt % moisture (e.g., 10 wt % water), at least about 20 wt % moisture (e.g., 20 wt % water), at least about 30 wt % moisture (e.g., 30 wt % water), at least about 40 wt % moisture (e.g., 40 wt % water), at least about 50 wt % moisture (e.g., 50 wt % water), at least about 60 wt % moisture (e.g., 60 wt % water), and at least about 70 wt % moisture (e.g., 70 wt % water); in such embodiments, the ranges of moisture can have upper limits such as at least about 10 wt % moisture (e.g., at least about 10 wt % water), at least about 20 wt % moisture (e.g., at least about 20 wt % water), at least about 30 wt % moisture (e.g., at least about 30 wt % water), at least about 40 wt % moisture (e.g., at least about 40 wt % water), at least about 50 wt % moisture (e.g., at least about 50 wt % water), and at least about 60 wt % moisture (e.g., at least about 60 wt % water), at least about 70 wt % moisture (e.g., at least about 70 wt % water), and at least about 75 wt % moisture (e.g., at least about 75 wt % water).

Using these parameters, ranges for embodiments such as the following are consistent with the principles of the invention:
Lower limit of range, about 5 wt % moisture; upper limit of corresponding range about 10 wt % moisture, or about 20 wt % moisture, or about 30 wt % moisture, or about 40 wt % moisture, or about 50 wt % moisture, or about 60 wt % moisture, or about 70 wt % moisture, or about 75 wt % moisture
Lower limit of range, 10 wt % moisture, upper limit of corresponding range about 20 wt % moisture, or about 30 wt % moisture, or about 40 wt % moisture, or about 50 wt % moisture, or about 60 wt % moisture, or about 70 wt % moisture, or about 75 wt % moisture
Lower limit of range, 20 wt % moisture, upper limit of corresponding range about 30 wt % moisture, or about 40 wt % moisture, or about 50 wt % moisture, or about 60 wt % moisture, or about 70 wt % moisture, or about 75 wt % moisture
Lower limit of range, 30 wt % moisture, upper limit of corresponding range about 40 wt % moisture, or about 50 wt % moisture, or about 60 wt % moisture, or about 70 wt % moisture, or about 75 wt % moisture
Lower limit of range, 40 wt % moisture, upper limit of corresponding range about 50 wt % moisture, or about 60 wt % moisture, or about 70 wt % moisture, or about 75 wt % moisture
Lower limit of range, 50 wt % moisture, upper limit of corresponding range about 60 wt % moisture, or about 70 wt % moisture, or about 75 wt % moisture
Lower limit of range, 60 wt % moisture, upper limit of corresponding range about 70 wt % moisture, or about 75 wt % moisture
Lower limit of range, 60 wt % moisture, upper limit of corresponding range about 70 wt % moisture, or about 75 wt % moisture

Also, using the parameters above, ranges for embodiments such as the following are consistent with the principles of the invention:
Lower limit of range, about 5 wt % water; upper limit of corresponding range about 10 wt % water, or about 20 wt % water, or about 30 wt % water, or about 40 wt % water, or about 50 wt % water, or about 60 wt % water, or about 70 wt % water, or about 75 wt % water
Lower limit of range, 10 wt % water, upper limit of corresponding range about 20 wt % water, or about 30 wt % water, or about 40 wt % water, or about 50 wt % water, or about 60 wt % water, or about 70 wt % water, or about 75 wt % water
Lower limit of range, 20 wt % water, upper limit of corresponding range about 30 wt % water, or about 40 wt % water, or about 50 wt % water, or about 60 wt % water, or about 70 wt % water, or about 75 wt % water
Lower limit of range, 30 wt % water, upper limit of corresponding range about 40 wt % water, or about 50 wt % water, or about 60 wt % water, or about 70 wt % water, or about 75 wt % water
Lower limit of range, 40 wt % water, upper limit of corresponding range about 50 wt % water, or about 60 wt % water, or about 70 wt % water, or about 75 wt % water
Lower limit of range, 50 wt % water, upper limit of corresponding range about 60 wt % water, or about 70 wt % water, or about 75 wt % water
Lower limit of range, 60 wt % water, upper limit of corresponding range about 70 wt % water, or about 75 wt % water
Lower limit of range, 60 wt % water, upper limit of corresponding range about 70 wt % water, or about 75 wt % water

Ranges falling within the disclosed ranges set forth above are also contemplated as consistent with the principles of the invention.

While the ranges set forth above contemplate the preparation of materials with moisture content (e.g., water content) ranging from about 5 wt % to higher amounts of moisture, any solid or semi-solid material derived from a redispersible-NCE-containing formulation and retaining less than about 10 wt % moisture (e.g., about 10 wt % water) is termed “fully dry.” As used herein the term “dried” includes both partially dried and fully dried materials; the term “drying” includes both “partial drying” and “fully drying.” However, a “partially dried” product and a “fully dried” product are mutually exclusive. The availability of partially dried products derived from redispersible-NCE-containing formulations offers distinct advantages.

Without being bound by theory, it is understood that when creating a fully dried NCE-containing product, all the unbound water that was interacting with the hydroxyl groups of individual NCE fibrils and preventing fiber-fiber interactions has been removed. Therefore, to eliminate or inhibit the formation of irreversible fiber-fiber bonds a high enough concentration of additives is required to space out fibers and offer an alternative site for them to bond. As has been disclosed in the '521 Application and as is described herein, a number of additives have been identified that accomplish this process, allowing the fibers to be unlocked from each other even after they have come into proximity with each other within the dried product. Certain additives as described below are used to produce redispersion in situations that include both partial drying and full drying. These latter additives are termed “drying/dispersal additives” or “redispersion aids” or “redispersion additives,” and those terms are used interchangeably herein. Such additives permit the redispersion of the NCEs contained a dried (i.e., partially dried or fully dried) product.

As used herein, the term “redispersion” and its grammatical derivatives and congeners refer to a process by which the dried NC material is suspended in a fluid medium (whether aqueous or non-aqueous) termed a “resuspending fluid,” so that there is a substantially complete dissolution of the dried NC material (whether semi-solid or solid) into its component NC elements. In embodiments, aqueous resuspending fluids can be used; in other embodiments, non-aqueous resuspending fluids can be used, such as fluids having hydrophobic properties or amphiphilic properties. In embodiments, redispersion results in a suspension of the NC elements so that they are formed as individual NC elements or coalescences of individual NC elements (either, referred to herein as a “resuspended particles”) wherein such resuspended particles have an aspect ratio of greater than 10. In embodiments, the resuspended particles have an aspect ratio between about 10 and about 300, or between about 10 and about 200. In embodiments, the resuspended particles have an aspect ratio between about 50 and about 150. In embodiments, the resuspended particles have an aspect ratio between about 25 and about 75. In other embodiments, the resuspended particles have an aspect ratio between about 75 and about 125.

Redispersion additives can be combined with NCEs through various mixing methods. In embodiments, it has been found that high shear mixing is an advantageous method for achieving full interaction of additive and NCEs. For instance, an Ultra Turrax homogenizer may be used at 3,000-23,000 rpm to help blend NFC elements. A high shear mixing attachment for overhead stirrers or larger mixers is also useful for blending NCEs with additives, examples of impeller designs include dispersion/saw tooth, anchors, chain paddle, beater paddles, coil stirrers, and more. In embodiments, VISCO JET impellers have been particularly successful for achieving uniform blending of highly viscous slurries. With increasing solids content of the redispersion solution, the higher amount of shear is required to eliminate any existing fiber bundles and achieve complete fiber unlocking and complete interaction with the additives. For example, a 2 wt % fiber solution mixes well with a standard overhead mixer impeller at 1000 rpm or an Ultra Turrax at 3,000 rpm whereas a 7 wt % fiber solution has difficulty mixing with either of those two mixers even at higher rpm. In the case of the 7 wt % fiber solution a more aggressive mixer is required such as a multi shaft mixer that has an anchor, a disperser, and a high shear rotor/stator mix head. High-speed disperses, high-shear rotor-stator, in-line homogenizers, and combinations thereof are able to apply the necessary shear to high solid formulations to achieve homogeneity.

It is understood that the drying/dispersal additives disclosed herein can be introduced into a NC-containing suspension individually or in combination to improve the drying process for the NC and to facilitate its redispersion. Drying/dispersal additives can also be used in combination with other agents that enhance their efficacy, even if those other agents are not effective as drying/dispersal additives when used alone; such agents, used in combination with the drying/dispersal additives to enhance their efficacy or efficiency, are termed “adjuvants.” It is further understood that one or more of the drying/dispersal additives or adjuvants can act together in a synergistic manner. Moreover, combinations of the drying/dispersal additives can be introduced sequentially during the preparation of the initial NC suspension, and/or before, after, or during the processes that are employed to produce the initial NC suspension from a feedstock of cellulosic sources, with or without the addition of adjuvants. For example, non-polymeric additives can be added during the processes that are employed to produce the initial NC suspension from feedstock, but desirably are to be added after chemical pretreatment of the initial NCEs that are derived from the cellulosic or lignocellulosic precursor material. Additives can be first dissolved in water and then added to the NC suspension or they can be directly added to the NC suspension without prior introduction to water.

It has unexpectedly been discovered that water can act as an adjuvant that enhances redispersibility and redispersion when it remains behind during the drying process to be included in the partially-dried material derived from a redispersible NCE-containing formulation, so that it can facilitate the redispersion of NCEs when the partially-dried material is exposed to a redispersing fluid. As mentioned previously, the presence of a certain amount of water in a partially dried material derived from a NCE-containing formulation can act as an adjuvant to the drying/redispersion additive(s) in the material. Water acts as an adjuvant to enhance redispersion when present in the partially dried material, that is, in the absence of full drying. This happens because water itself acts as a blocking agent by hydrogen bonding with the fibrils and preventing fiber-to-fiber bonding. The presence of water is ensured by a variety of drying mechanisms that are compatible with partial drying, enabling the water to act as an adjuvant to the drying/dispersal additives in the NCE-containing formulation. The use of drying/dispersal additives in a formulation in combination with drying mechanisms compatible with partial drying yields a redispersible product with a lower requirement for drying energy and a lower total additive loading. For example, additive loadings below 30 wt % with respect to NCEs can be obtained for those formulations intended for partial drying.

### 2. Drying/Dispersal Additives

While certain additives (for example, certain LCST polymers, as described below) are suitable for use as single agents for facilitating drying and redispersion, other additives lend themselves for use as adjuvants in combination with a main drying/dispersal additive, either administered into the initial NC suspension simultaneously with the main additive, or as pre-treatment to the initial NC suspension or any precursor thereof before adding the main additive, or as a post-treatment to the initial NC suspension following the addition of the main drying/dispersal additive. Drying/dispersal additives comprise, without limitation, temperature-responsive polymers, small molecule additives in volatile systems, and blocking agents. The drying/dispersal additives such as are described below can be used alone or in combination; it is understood that two or more drying/dispersal additives from a single category (e.g., temperature-responsive polymers, small molecule additives in volatile systems, and blocking agents) can be used together, or one or more additives from different categories can be used together. Main drying/dispersal additives and adjuvant additives that are used in combination with a source of NC elements to produce the liquid formulations and derivative redispersible dried materials of the present invention are termed, collectively, “primary additives.”

a. Temperature-Responsive Polymers

In embodiments, certain temperature-responsive polymers can be employed to create space between the NC elements during drying, thereby preventing the NC elements from aggregating during the drying process. Temperature-responsive polymers especially suitable for this purpose are those that exhibit a phenomenon known as LCST (lower critical solution temperature) phase behavior. It is understood that certain LCST polymers are hydrophilic below their LCST transition temperature and become reversibly hydrophobic above their LCST transition temperatures. In other words, below the LCST point, the polymer shows high affinity towards water, consistent with its intrinsic molecular hydrophilicity. However, above the LCST point, the polymer repels water and shuns hydrogen bonding. This is evidenced by the observed thermogelation of polymer solutions above this transition temperature. As the polymeric or oligomeric LCST additive self-assembles on the surface of the NC elements (in the form of mono-layer or a few molecular layers), drying of NC elements are affected so that their ultimate redispersion is facilitated.

In more detail, the LCST polymer can be added to the initial NC suspension at a temperature below the LCST polymer's transition temperature. As water evaporates from the initial NC suspension during drying, its temperature rises and approaches the boiling point of water, coming to exceed the LCST polymer's transition temperature, at which point the LCST polymer loses its hydrophilic character and becomes hydrophobic. When it becomes hydrophobic, the LCST polymer interferes with the hydrogen bonds that are forming between the NC elements. The hydrophobic nature of the LCST polymer now dictates aggregation or disaggregation of the NC elements, instead of these processes being driven by the interaction of the cellulosic units of the NC elements.

In embodiments, selected LCST polymers can markedly or completely hinder the dense aggregation of NC elements upon drying. In embodiments, the ability of selected LCST polymers to disrupt aggregation of NC elements is independent of equipment selection and manner of drying. For example, the suspension containing the LCST polymer and the NC elements can be left quiescent during drying. A wide range of drying temperatures and pressures can be applied to the initial NC suspension in the presence of selected LCST polymers to accomplish aggregate-free drying. Dried NC materials produced using selected LCST polymers as described herein can be readily redispersed in water with gentle agitation or stirring, with minimal or no clotting or residual aggregations identified in the redispersed suspension. These features give rise to wide latitude in parameters for redispersion and for processing the redispersed material.

In embodiments, the list below offers examples of LCST polymers and their analog short-chain oligomers that can be used to prevent aggregation and facilitate redispersion of NC elements.
Methyl cellulose
Carboxymethyl cellulose
Sodium carboxymethyl cellulose
Hydroxyethyl cellulose
Hydroxypropyl cellulose
Hydroxypropylmethyl cellulose
Ethylhydroxyethyl cellulose
Polyvinylcaprolactam
Poly(methyl vinyl ether)
Poly(N-isopropylacrylamide)
Poly(N,N-diethylacrylamide)
Poly(N-vinylcaprolactam)
Block copolymer of poly(ethylene oxide) and poly(propylene oxide)
Poly(pentapeptide) of elastin
Polyethylene glycol and its derivatives
Polypropylene oxide
Methoxy-terminated oligo (ethylene glycol)

Note that thermo-gelation temperature of the cellulose derivatives listed above depends on the type and degree of substitution and is tunable by structural design. Advantageously, a selected LCST polymer for use as a drying/dispersion additive can have a transition temperature that is greater than the ambient temperature (for example, >25° C.), so that the polymer remains in solution until the drying step commences.

In embodiments, a LCST polymer can be used advantageously with a blocking agent, such as are described below. LCST polymers have been shown to be the most effective of all drying/dispersal aids under those circumstances in which only a single drying/dispersal aid is employed. Blocking agents can also be used alone to achieve good redispersion, but may require a very high loading rate to achieve full redispersion. Using an LCST polymer in combination with a blocking molecule has been found to be highly cost-effective while meeting stringent dispersion conditions.

In embodiments, it has been observed that the size of the redispersion aid influences its efficacy as size influences the additive's mobility. For example, an LCST polymer typically has a molecular weight from around 10,000 g/mol upwards of 1,500,000 g/mol whereas a preferred blocking agent typically has a molecular weight below 500 g/mol. The long chains of the LCST polymers are advantageous due to the high amount of hydrogen bonding sites contained in a single chain, which therefore allows a single chain to interrupt bonding across many fibers. By contrast, the blocking agents have fewer hydrogen bonding sites per chain, and their short structure allows for greater mobility between fibers and throughout the NFC solution. Without being bound by theory, it is believed that combining longer chains that can attach to readily available fibers with blocking agents that can travel to the harder to reach fibers helps achieve complete redispersion with lower total additive loading.

b. Volatile Small-Molecule Additives Systems

In embodiments, volatile systems comprising small molecule additives can be employed to create space between the NC elements during drying to prevent the NC elements from aggregating during the drying process, either alone or in combination with other additives. The selected small molecule additives for use with volatile systems are miscible with water and have a boiling point higher than that of the co-existing water. A small molecule additive useful in a volatile system is further characterized by its greatly lower hydrogen-bonding tendency compared to water. As the additive-loaded volatile system containing the NCEs and the selected small molecules undergoes drying, water molecules evaporate preferentially, leaving the small molecule additive behind due to its higher boiling point and thereby increasing the concentration of the additive in the solution that remains between adjacent NC elements.

In embodiments, the molecular segments of the volatile small molecule additives comprise both polar and non-polar functionalities. Not being bound by theory, it is envisioned that the polar segments are attracted by the cellulosic hydroxy groups while the non-polar segments simultaneously interfere with hydroxy-hydroxy interactions, thus reducing adherence between and among the NC elements. Then, as the temperature in the system rises, the additive evaporates, leaving behind the NC elements surrounded by air. The resulting dried material, containing NC elements that are separated from each other by air, can be readily re-dispersed without the formation of observable clumps/clots or concentration variations. The redispersed suspension comprises resuspended NC particles that are uniform in distribution within the suspension, wherein the NC elements retain their nano-size characteristics and can achieve redispersion with only very mild agitation/stirring.

In embodiments, the lists below offer examples of small molecule additives that can be used as drying/dispersal additives in the aforesaid volatile systems to prevent aggregation and facilitate redispersion of NC elements. Exemplary additives can be divided into two categories: non-ionic and cationic compounds.

Non-ionic candidates can include, without limitation:
Tri (propylene glycol) butyl ether (TPnB)
Di(propylene glycol) propyl ether (DPnP)
Propylene glycol butyl ether (PnB)
Propylene glycol propyl ether (PnP)
Ethylene glycol monobutyl ether
Propylene glycol monomethyl ether acetate
Propylene glycol diacetate
Ethylene glycol diacetate
Benzyl alcohol
1-Heptanol
1-Hexanol

Cationic candidates can include, without limitation:
Ethylene diamine
Diethylene triamine
Tetraethylene pentaamine
1,3-Pentane diamine
Piperazine
1,2-Cyclohexane diamine
Aniline
Pyridine

In embodiments, the small molecule additives can evaporate completely from the initial NC suspension, just leaving behind the NC elements without additive residue. However, in other embodiments, trace amounts of the small molecule additives can remain. For example, with certain cationic additives, their cationic groups can adhere to cellulose molecules, so that trace amounts of the additive remain adherent to the cellulose after complete drying. For most industrial applications, the trace residues of these additives do not pose health or environmental problems. However, in embodiments, a biodegradable cationic small molecule such as 1,3-pentane diamine is advantageous.

c. Blocking Agents

In addition to those small molecules that can function as drying/dispersal additives, certain non-volatile small or large molecule additives or particulate matter can be employed for the same purpose. Such molecules or substances, since they are non-volatile, act more durably within the NCE matrix to hinder hydrogen bonding and/or to create space between the NC elements during drying by obstructing, interfering with, or physically distancing interactions between the NC elements and thus preventing the NC elements from aggregating during the drying process. In embodiments, particles, e.g., nanoscale particles, can be surface-functionalized or otherwise treated so that they act in the same manner. Such non-volatile small or large molecule additives and nanoscale particles carrying out this blocking function are referred to herein as blocking agents or blockers As used herein, the term “blocking agent” or “blocker” includes any non-volatile chemical additive or nanoscale particulate material that itself hinders hydrogen bonding or creates spaces among NC elements, whether the substance is interposed between or among NC elements, or whether the substance offers temporary competitive binding sites for the NC elements, or otherwise.

As an example, caffeine and other xanthine derivatives are small-molecule blockers that can be used advantageously to facilitate isolation and re-dispersion of NC elements. Not being bound by theory, it is envisioned that the aromatic nitrogen atoms in certain purines (such as caffeine and other xanthines or xanthine derivatives) and pyrimidines can become hydrogen-bonded with the hydroxy groups of the cellulose, presenting a flat, relatively non-polar, and molecularly-lubricating and water-screening outer surface for the NCEs thus treated that resists adhesion with other NCEs. Advantageously, caffeine, and other xanthines and xanthine derivatives employed as blocking agents can typically be used in quantities that do not present health or environmental problems, even when these substances are used in sufficient dosages to facilitate NC redispersion.

As another example, certain humectant substances can be employed as blocker molecules. Humectants possess multiple hydrophilic sites (hydroxyls, esters, and ammonium groups) that can form hydrogen bonds with the surface of the NC elements, thus impairing the interaction of these elements with each other via hydrogen bonding and thereby impairing their aggregation. With their aggregation impaired, the redispersion of the NC elements is facilitated. Advantageously, these hygroscopic substances are biocompatible and are already widely used in the pharmaceutical, cosmetic, and food industries. Exemplary short and long humectant candidates include but are not limited to: glycerin, caprylyl glycol, ethylhexylglycerin, tribehenin, hydrolyzed soy protein, propylene glycol, methyl gluceth-20, phenyl trimethicone, hyaluronic acid, fulvic acid, sorbitol, polydextrose, triglyceride, and gelatin.

In embodiments, a variety of other non-volatile molecules having similar properties can act as blocking agents, thereby fostering redispersibility. As described above, such molecules can be characterized by their ability to impair aggregation between the NC elements, for example by forming hydrogen bonds with the surfaces of the NC elements or by otherwise interfering with the attachment of the NC elements with each other. By impairing the aggregation of the NC elements, these blocking agents facilitate the redispersibility of such NC elements. Examples include, without limitation, polyols (e.g., sugar alcohols such as alditols), glycols, surfactants, salts, monosaccharides, disaccharides, polysaccharides, and the like. Without being bound by theory, molecules like polyols and glycols and saccharides have hydroxyl groups, which allow them to disrupt hydrogen bonding between the fibers and water because they can bond with the fibers themselves. Without being bound by theory, surfactant molecule can act as blocking agents because their hydrophilic regions can interact with the hydroxyl groups on the NCE fibers. and their hydrophobic tails can help create space between the fibers. Examples of polyols, glycols, surfactants, and salts can include, without limitation, the following:
Polyols: arabitol, erythritol, galactitol, glycerol, isomalt, lactitol, maltitol, mannitol, ribitol, sorbitol, xylitol

Glycols: propylene glycol, dipropylene glycol, tripropylene glycol, polypropylene glycol, polyethylene glycol
Surfactants: sodium lauryl sulfate, sodium laureth sulfate, sodium lauroyl sarcosinate, sodium caprylyl sulfonate, sodium octyl sulfate, ammonium lauryl sulfate, ammonium laureth sulfate, cocamide monoethanolamine, cocamide diethanolamine, polyoxyethylene sorbitan monopalmitate, polyoxyethylene sorbitan monostearate, polyoxyethylene sorbitan monooleate, capryl glucoside, glucopon (APG), and coco glucoside
Salts: sodium chloride, calcium chloride, potassium chloride, zinc chloride, calcium carbonate, magnesium sulfate, potassium bicarbonate, and the like
Monosaccharides, Disaccharides, and Polysaccharides: maltodextrin, dextrin, sucrose, fructose, glucose, starch, glycogen, chitin, chitosan, agar, carrageenan, fucoidan, xanthan gum, pullulan, inulin, beta-glucan, glucomannan, and the like.

As another example, fatty acids can be employed as blockers as well. Fatty acids contain hydrophilic sites and a hydrophobic tail. The hydrophilic site can form hydrogen bonds with the surface of NC elements, thus screening the interaction of these elements with each other via hydrogen bonding, and thereby impairing aggregation. Advantageously, fatty acids can be selected that do not contain so many hydrophilic sites that much hydrogen bonding will occur between fibers and the blockers. In embodiments wherein too many hydrogen sites may cause aggregation, the hydrophobic tail of the fatty acid blockers can act to physically prevent aggregation of NC elements by preventing or interfering with hydrogen bonding. In embodiments, the blocking agent can be a fatty acid, such as stearic acid, palmitic acid, myristic acid, lauric acid, capric acid, caprylic acid, caproic acid, octanoic acid, and the like. To facilitate dispersion, a water-soluble fatty acid may be preferable.

Larger molecules can also be used as blocking agents as well. For example, the main fatty acid found in castor oil (ricinoleic acid) has a large blocky structure with areas capable of hydrogen bonding, allowing it to disrupt hydrogen bonding between fibers by bonding with NFC hydroxyls upon water removal and by physical spacing fibrils apart with its long hydrocarbon chains.

In embodiments, particles of appropriate configurations can be used as a blocking agents to prevent NCE aggregation. Nanoscale particles can be prepared with surface functionalities so that they replicate the behavior of the non-volatile molecules described above by blocking hydrogen bonding or disrupting hydrogen bonding. In embodiments, larger scale fibers such as pulp can be used similarly as blocking agents to prevent NCE agglomeration. Since pulp fibers have not been fibrillated to the same degree as NCEs, they have far fewer exposed hydrogen bonds and do not irreversibly agglomerate. Pulp fibers act as blocking agents physically by further spacing out NCE fibrils to encourage bonding with the pulp rather than with themselves. It is possible, however, that some NCE fibrils may irreversibly agglomerate onto the pulp fibers during drying so that complete redispersibility is impeded. Pulp is particularly suitable as a blocking agent for those formulations wherein there is tolerance for some agglomeration when the final product is redispersed.

Additive loading can vary based on the end-use requirements. Generally, low additive loading <20 wt % (% relative to total dry weight of the sample) is preferred to maintain the original properties of the fiber itself. More preferably, one can load additives at a percentage equal to or less than 10 wt %. If using an LCST and a blocking agent at low total additive loading, a similar amount of each redispersion aid can be used. For example, equal amounts of an LCST and blocking agent can be used in the following ratios to NFC (NFC: Blocking agent:LCST): 98:1:1, 38:1:1, 34:1:1, 28:1:1, 18:1:1, 8:1:1, and all loadings in between.

d. Additive Loading

Higher additive loading is preferred for those embodiments in which the dispersion aids contribute to the performance of the end product. For example, if preparing a high-solids redispersible sheet for certain uses such as cosmetics, with HPMC and glycerol as the additive redispersion aids, loading these additives in large amounts, such as a 50 wt % additive loading, can be employed satisfactorily because these two dispersion agents are also commonly used as viscosity modifiers in cosmetics. This same reasoning would justify the relatively high amount of redispersion additive loading for other use cases in which the redispersion additives are also carrying out a secondary function in the sheet, such as viscosity modification. When formulating sheets with such relatively higher loads of redispersion aids as additives, it is advantageous to use a larger amount of the blocking agent additive than the LCST additive. For example, when preparing a sheet with a 50 wt % additive loading of redispersion aids, the following ratio of NFC:Blocking agent:LCST can be used 5:4:1, 5:3:2, 10:7:3, 10:9:1, 2:1:1. For a sheet with 40 wt % additive loading of redispersion aids the following ratios can be used: 12:7:1, 12:5:3, 6:3:1, 3:1:1. For 30% additive loading the following ratios can be used: 7:2:1, 14:5:1, 14:3:3. For 20 wt % the following ratios can be used: 32:7:1, 32:5:3, 16:3:1, 8:1:1. For use cases in which higher rheology modification is desirable, relatively larger amounts of LCST redispersion aids can be used vs the amount of the blocking agent in the additive. For example, when preparing a sheet with a 50 wt % additive loading of redispersion aids to obtain higher rheology modification, ratios of NFC: Blocking agent:LCST such as 5:4:1, 5:3:2, and similar proportions, or LCST and blocking agent amount can be the same or similar.

In certain embodiments, one can increase loading of redispersion aids above 50 wt % if very fast dispersion at low shear is required, preferably for those applications in which the redispersion aids are compatible with each other. If the redispersion aids employed are in the end use formulation, it can be advantageous to load at high rates >wt50% loading. This can also be advantageous if preparing redispersible NCE-containing fibers intended for use in a nonpolar polymer matrix. In embodiments, high loading of dispersion aids can enable superior dispersion of such additives into smaller amounts of water or into the sheets themselves if used directly, for example in a hot melt mix. In an exemplary embodiment, a dispersion aid sheet where HPMC is the selected redispersion additive could be formed by directly adding the HPMC into a hot melt above the melt temperature of HPMC. Other LCST polymers, such as methylcellulose or carboxymethylcellulose (without limitation) can also be employed in addition to or instead of HPMC. Glycerol can also be advantageously employed for the same end use as described above for HPMC and other LCST polymers, since it is commonly used as a plasticizer in composite systems and is compatible with other agents in a hot polymer or biopolymer melt. In exemplary embodiments, glycerol can be used itself as a redispersion aid (in addition to or instead of LCST polymers); it is understood that either type of redispersion aid can be used by itself at high loading doses to make a sheet as described above, or can be used in conjunction with other redispersion aids. Similarly, other polyol blocking agents can be selected as the redispersion aid, offering advantages by serving a second purpose of plasticizing the matrix in which the redispersible NCE-containing sheet is dispersed; for example, agents such as sorbitol or xylitol alone or in combination with other agents can be used for this purpose.

e. Additional Processing Options

Processes for forming NC-containing suspensions (i.e., initial NC suspensions) suitable for treatment using the formulations and methods disclosed herein are familiar in the art. To form such a NC-containing suspension, cellulose sources can be processed using mechanical techniques and optional chemical treatments to extract the component cellulose nanomaterials and retain them as suspended in a liquid medium. The NC elements thus extracted form the initial NC suspension, which can be treated using the disclosed formulations and methods.

In more detail, mechanical treatments such as high-pressure homogenization, microfluidization, super-grinding, cryo-crushing, steam explosion, refining, and high-intensity ultrasonication are known in the art for disintegrating the cellulose source materials to yield their component NC elements; other mechanical techniques will be familiar to artisans in the field having ordinary skill. Such mechanical treatments can be termed forms of mechanical defibrillation. Mechanical treatments, however, require considerable amounts of energy. Therefore, in order to reduce energy consumption during the mechanical defibrillation processes, a variety of chemical and enzymatic strategies have been employed to pretreat the cellulose sources before their mechanical processing, such strategies being collectively termed “chemical pre-treatments” herein. In addition, chemical modification of the NC elements can be performed after mechanical defibrillation to alter their properties.

Drying/dispersal additives as disclosed herein can be used in the various suspensions of partially treated cellulose sources, instead of or in addition to being used to treat the primary NC suspension resulting from the extraction of the NC elements from the cellulose source feedstock. In exemplary embodiments, a single drying/dispersal additive can be used to treat a feedstock suspension of partially treated cellulose sources, for example a suspension of cellulose sources that has been pretreated chemically but have not yet been subjected to mechanical defibrillation. For example, a volatile additive can be used in this way. Volatile additives are typically formulated as non-viscous fluids that can be injected directly into the pulp feedstock suspension, for example after its chemical pretreatment and/or immediately before it undergoes mechanical defibrillation process (homogenizing, microfluidization, grinding, high intensity ultrasonication, and the like). In this manner, volatile moieties are intermingled between and among individual fibers as they detach from larger pulp (cellulose) strands, an architecture that is retained during mechanical defibrillation.

In another embodiment, a non-volatile additive or a temperature-responsive polymer such as a LCST polymer can be used to treat the partially-treated cellulose feedstock instead of or in addition to using a drying/dispersal additive to treat the initial NC suspension. Non-volatile additives, as well as LCST polymers, generally come as viscous fluids or powdered solids to be dissolved aqueous solutions. Due to their high viscosity, these components are desirably added after mechanical defibrillation, either by direct application/dissolution or by combining a concentrated solution of the additive with the NC suspension effluent.

In other embodiments, pretreatments with various pretreatment agents may be useful prior to adding the drying/dispersal formulations disclosed herein. For example, cellulose sources can be subjected to certain chemical pretreatments before mechanical defibrillation, as mentioned above. Chemical pretreatments such as enzymes, alkaline-acid solutions, and/or ionic liquids, for example, can break down lignin and hemicellulose in cellulose sources, while preserving cellulose moieties. These chemical pretreatments help reduce the energy consumption of subsequent mechanical processing, as described previously. Furthermore, chemical pretreatments can render the surface chemistry of the extracted NC elements more receptive to treatment with the drying/dispersal additives disclosed herein. It is known that the surface chemistry of NC elements varies, depending on both the raw source of the cellulosic material (e.g., softwood, hardwood, soy hulls, wheat straw, bagasse, sugar beet pulp, and the like) and the processing technique implemented (e.g., Kraft vs Sunburst). Moreover, additional chemical treatments such as carboxymethylation, oxidation, and sulfonation can be implemented during industrial processes to create permanent anionic charges on the NC surfaces. To optimize the surface chemistry of a population of NC elements for treatment with the drying/dispersal additives disclosed above, these elements can be pretreated with short amines or positive oligomeric species to mitigate ionic forces between the NC elements; such pretreatment can be carried out before or in conjunction with adding the drying/dispersal additives. Examples of such pre-treatment agents include: ethylene diamine, o-phenylenediamine, diethylenetriamine, tetraethylenepentamine, 1,3-diaminopentane, ethanolamine, triethynolamine, melamine, and EDTA; other pre-treatment agents will be familiar to those having ordinary skill in the art.

In certain embodiments, chelating agents such as EDTA or comparable chelating agents such as MGDA (methylglycinediacetic acid trisodium salt), GLDA (tetrasodium glutamate diacetate), GEDTA (EGTA) (ethylene glycol-bis (β-aminoethyl ether)-N,N,N′,N′-tetraacetic acid), and the like, are useful as pre-treatments if a hard water source is employed to suspend the NC elements. In an embodiment, an LCST polymer can be selected as a drying/dispersal additive, to be used in a NC suspension after using or simultaneous with using EDTA to chelate the hard water cations. In embodiments, a chelating agent such as EDTA can be used to treat the initial NC suspension, thereby complexing divalent cations resident in the suspending fluid.

Other useful pre-treatments can be readily envisioned by those having ordinary skill in the art.

### 3. Methods for Partial Drying

Partial drying methods of redispersible-NCE-containing formulations permit the co-presence of water in the redispersible-NCE-containing substance, with the water acting as an adjuvant to those the drying/dispersal additive(s) described above. The presence of water in the partially dried redispersible-NCE-containing substance allows for the use of a lower amount of drying/dispersal additives in the redispersible-NCE-containing formulation that gives rise to the substance. Furthermore, such a partially dried substance can be redispersed using less intense mixing techniques for the redispersion process and/or less mixing time, with less energy required.

In embodiments, the form factor attained by the redispersible-NCE-containing formulation during processing can influence how quickly the partially-dried formed material disperses. The higher the surface area to volume ratio, the faster the partially-dried formed material redisperses since water can quickly penetrate through the surface and interact with the inner fibrils in a quick manner. The lower the surface area to volume ratio, the slower the partially-dried formed material redisperses since it takes longer for the water to penetrate the bulk of material. For example, when a crumb like partially-dried material is produced with spherical like fiber clusters, as is produced by certain dewatering techniques using a heated bath while mixing the redispersible-NCE-containing formulation, these partially dried materials will take longer to redisperse, in comparison to thin sheets with the same water content and additive loading. Additionally in a flat form factor the interactions between NCE fibers are limited, because their interactions in the z-plane are limited by the thinness of the formulation layer being dried. In contrast, when drying a thicker layer or a three-dimension bulk volume, the NCE fibers can bond in all three planes with the other surrounding fibers. The thinner the material, the majority of fibers are on the surface plane rather than in the bulk. Limiting the number of bulk fibers in the material will lead to fewer fiber-fiber interactions, requiring less additives to preserve redispersibility, and leading to faster redispersion; thicker form factors with more three-dimensional bulk volume will experience more fiber-fiber bonding and often require higher additive loading and experience slower redispersion. Therefore, advantageously, the wet thickness of the starting redispersible NCE film is 2 mm or less.

Water is especially advantageous as a spacing agent to limit NCE fiber-fiber interactions while the redispersible NCE-containing solution is being processed into a sheet-like form factor. For example, when spreading a 2 wt % solution out the large quantity of water in the formulation will help space the fibers out from one another, further limiting their interactions during drying. By contrast, an 8 wt % fiber solution is much thicker, and will experience a much higher number of fiber-fiber interactions as it is being spread to the same thickness. Therefore, in a preferred embodiment, the partial drying process can begin with a relatively high water concentration (94-99.99 wt % water) when forming a thin sheet as the form factor for partial drying, in order to limit the required additives needed for redispersion and/or to limit the energy needed for deploying the formulation into the desired thin-sheet form factor. In other embodiments, the partial drying process can begin with a lower quantity of water (85-93.99 wt %), although under these circumstances it is desirable to maintain a thin wet thickness, preferably less than 1 mm.

a. Thermal Drying Methods

Partial drying may be achieved through the use of a variety of thermal drying mechanisms including heat pressing/thermoforming, drying in a continuous belt dryer, drying on a drum dryer, batch drying in ovens, heated mix chambers, spray dryers, flash dryers, zeta dryers, vacuum dryers, and the like. In all these processes it can be advantageous in embodiments to keep the temperature of the NCEs below about 150° C. to avoid burning and decomposition of the fibers. In certain embodiments, it can be advantageous to use higher temperatures for the overall solution, for example within a range of about 150-250° C., so long as the temperature for the cellulose fibers themselves does not exceed the threshold temperature, e.g., a temperature of about 150° C. to avoid burning and decomposition of the fibers, as mentioned above. It has been observed that heating a solution with high volumes of water present tends to insulate the fibers from the effects of heat; it has been observed that temperatures up to 200° C. can be tolerated so long as the temperature of the fibers themselves are controlled. It has been further observed that heating the material between about 60-140° C. results in an efficient drying process and allows for fine tuning of the final solids content, although the air temperature of the oven may be much higher (about 100-300° C.). In embodiments, partial drying of a sheet containing at least 10 wt % water content can be undertaken at 200° C. without any fiber burning or yellowing, but when the sheet is left in the oven to reach full drying, fiber burning or yellowing occurs. Without being bound by theory, it is understood that when a sheet is partially dried, for example having a solids content between about 30 wt % solids to about 75 wt % solids, the remaining moisture in the sheet (in the foregoing example, about 70 wt % moisture to about 25 wt % moisture (e.g., about 70 wt % water to about 25 wt % water) can protect it against yellowing or burning concerns. Several illustrative embodiments of useful drying mechanisms for partial drying are provided below.

In embodiments, heat press or thermoformer can be used to partially dewater NCE-containing formulations to a desired moisture level quickly. By applying heat via direct contact from either side of the redispersible-NCE-containing formulation, the heat press/thermoformer rapidly raises the temperature of the solution above its boiling temperature, resulting in the fast escape of steam from the pressed material and leading to its consolidation of a partially-dried semi-solid or solid substance. The time and temperature at which the redispersible-NCE-containing formulation is pressed can be varied, depending on the desired end solids content (and its degree of partial drying) as well as the starting solids content. High water content to start often requires multiple presses at higher temperatures (120-160° C.). However, when a high amount of water is present in the starting material (>95 wt %), it is common to see steam explosions and the product produced lacks uniformity. When dewatering via heat press from a formulation or starting material with slightly less water (85-95 wt %) a more uniform sheet will be produced, and it is less likely for the sample to be dismembered due to steam explosion. Additionally lower temperatures (100-140° C.) and shorter press times are required to reach the desired solids content.

Advantageously, these drying mechanisms can be used to press the solution into a thin sheet material. In an embodiment, a thermoformer can be used, wherein the redispersible-NCE-containing solution is poured into a mold and pressed. The material used to form the mold must be carefully selected to prevent fibers from sticking. Some examples of suitable materials can include, without limitation, silicone, Teflon, parchment paper, coated metal, and the like. Using this type of equipment, a redispersible-NCE-containing solution can be formed into a thin sheet prior to pressing with a doctor blade, slot die, roller, and other manufacturing equipment with the ability to produce thin uniform sheets. Such sheets can be heated on both sides by a press mechanism in a thermoformer, or can be heated only on one side by exposure to a hot plate. Thinner sheets can more readily be heated uniformly on a hot plate, while thicker sheets can be treated by the application of heat on the top side and underside by a two-sided mechanism. Uniform thickness, though not required, can assist in achieving a more consistent distribution of the solids content in the partially dried product. Furthermore, uniform thickness results in more uniform drying across the entire material.

In embodiments, belt dryer system, such as a microwave oven, a flotation dryer, an impingement dryer, a steel belt dryer, a conventional belt dryer, or the like, can be used to dry redispersible-NCE-containing formulations partially, thereby achieving a partially dried material. Advantageously, both a heated belt and heated drying chamber to achieve uniform drying throughout the material since heat is transferred on both the top and bottom surfaces. Similarly, applying heated impinging air both above and below the belt can help achieve fast and uniform drying.

The redispersible-NCE-containing formulation or a partially dried redispersible-NCE-containing material formed therefrom can then be cast into a sheet or other shape prior to further drying techniques, such as the use of a slot die, manifold die, casting box, dip coater, blade coater, spin coater, mold casting, dropper, pastillator, roller, or similar equipment. It may be sprayed onto a mat or belt to form a uniform sheet; this requires a much lower starting solids content (<2 wt % fiber). A flow header or spreader, such as is seen commonly on the fourdrinier machine, can be used to evenly distribute the redispersible-NCE solution onto a solid or wire belt forming a thin sheet. Alternatively, a cylinder former, as is familiar in the paperboard industry, can be used to form a redispersible NCE web. When this device is submerged in the redispersible NCE solution, the wire-covered cylinder picks up fibers as the cylinder revolves, although this process can also contribute to additives being lost. Such redispersible-NCE-containing formulations or materials can be formed into a variety of shapes such as pastilles, pellets, spheres, cylinders, strands, and the like prior to further drying to produce a partially-dried solid or semi-solid.

Starting solids content can be varied based on the drying mechanisms being employed. For example, a solids content of about 4-10 wt % is preferred when drying in a microwave oven due to steam explosions producing holes in lower solids content sheets (<4 wt % solids). The resulting holes from microwave drying lead to uneven drying and nondispersible nits around the gap, this nonhomogeneous material leads to product inconsistencies and redispersion challenges. To minimize hole defects a low microwave power is ideal, for example, <2 kw. Higher microwave power, >2 kw, can be applied to higher solids content material if there is less concern over the formation of nits and defects in the material. In a convection oven where vaporization is the main drying mechanism, a lower solids content (<4 wt %) may be used without fear of steam explosion. However, a higher solids content (4-10%) may be deployed as well to minimize the time and energy required to partially dry.

Steel belt dryers deploy both mechanisms of drying, evaporation and vaporization) and can accommodate a variety of solids percentages. Unlike the microwave dryer, steam explosions are typically not an issue at lower solid % s with the steel belt dryer. Therefore it is preferred to use lower solids content with a steel belt dryer so the additional water can act as a fiber spacer and decrease fiber-fiber interactions leading to overall better dispersion at low shear mixing with lower additive loading. Depending on the end solids content and the final thickness the partially dried redispersible NCE may be lifted off the belt in sheet form and rolled, allowing it to be shipped as is or sent to a subsequent cutting step where the wet sheet is flaked. Alternatively, the material can be collected from the belt in pieces or sections rather than a continuous sheet. A plastic or metal scraper may be used to facilitate lifting or removing the partially dried redispersible NCE from the drum.

Certain versions of belt dryers such as impingement belt dryers utilize high-velocity, high-temperature air jets directed at the surface of the substrate to rapidly remove moisture due to efficient heat transfer. High temperature air can be deployed from above or below the substrate as well as from both directions simultaneously as seen with a flotation dryer. A temperature range of 140-250° C. is preferred to encourage rapid and uniform drying, as long as moisture remains present in the sheet to resist fiber degradation and yellowing. In embodiments, temperatures can be adjusted through individual zones of the belt, for example so that a higher temperature is first deployed and then a lower temperature is used later in the process to avoid overdrying.

A drum dryer or yankee dryer may be used to partially dry redispersible-NCE-containing formulations to achieve a partially dried material. Steam is used to heat the drum and creates a uniform temperature distribution. Redispersible NCE-containing formulations can be applied to the drum via nip feeding, roller feeding, dip feeding, slot or manifold dies, and more deposition mechanism. Once the solution is coated onto the heated drum the temperature of the solution rapidly rises above its boiling temperature, resulting in the fast escape of steam. An advantage of the drum dryer is uniform heating throughout; this results in a very homogenous partially dried redispersible NCE. A 1-4 mm wet thickness is ideal for the drum dryer; thinner wet thicknesses have resulted in difficulty in removal of the partially dried material from the drum. In embodiments, a temperature range of 60-110° C. can be employed, though a higher temperature range of 110-250° C. can be used if rapid drying is required. In embodiments, the speed of the drum can be adjusted to yield the desired solids content. Depending on the end solids content and the final thickness the partially dried redispersible NCE may be lifted off the drum in sheet form and rolled, allowing it to be shipped as is or sent to a subsequent cutting step where the wet sheet is flaked. Alternatively, the material can be collected from the drum in pieces or sections rather than a continuous sheet. A plastic or metal scraper may be used to facilitate lifting or removing the partially dried redispersible NCE from the drum.

A variety of heated mixing chamber systems can be employed to partially dewater redispersible-NCE-containing formulations. As an example, a water bath can be used to heat a container containing the redispersible-NCE-containing formulation, while simultaneously mixing it with an overhead mixer. For larger scale production, a jacketed sleeve on a mixing vessel can be used to heat the material while the mixer is operating. Systems involving heated mixing chambers can include mechanisms for maintaining constant circulation of the material in the mixing vessel, so that water is removed from the material uniformly during the process.

Processes using heated mixing chambers can yield a crumb-like material due to fiber raveling while mixing is carried out. The crumb-like material is less ideal for certain applications than sheets or other form factors with thin profiles due to increased fiber interactions in the z direction. In order to achieve the same redispersion performance at the same solids level as a partially dried sheet, the partially dried crumb material can be formulated with higher additive loading or processed with higher shear mixing. For example, a 60% solids redispersible thin sheet containing 10% dry weight additive loading produced via belt drying will disperse in 10-15 minutes under low shear conditions whereas a 60% solids crumb dried through a heated mixing chamber with the same additive loading will not disperse even after 60 minutes of mixing under the same low shear conditions.

A cylinder drying system, such as is used for paper drying systems, can be used to partially dewater redispersible NCE solutions. The system is composed of multiple heated rotating cylinders that heat a formed sheet on a moving belt as it passes through the system, removing water through evaporation. Typically, sheets with higher solids content are fed through the cylinder dryers during the papermaking process. For example, a pulp slurry that has been formed into a sheet typically reaches a minimum of 40 wt % solids before coming into contact with the heated cylinders where it is dried further. Although it may be possible to use a lower starting solids % with NFC, if a non-flowable solution is preferred the solution should contain a solids content higher than 4 wt % solids, or in embodiments, higher than 6 wt %. The solution may be partially dried prior to application onto the cylinder drying system either by mechanical or thermal dewatering methods. In embodiments, the starting thickness of the wet sheet is less than 2 mm; in other embodiments, the starting thickness of the wet sheet is less than 3 mm. Other thicknesses can be employed, depending on the partial drying methods that are utilized.

Certain general trends are observed when drying in any of the thermal methods. As examples, lower starting solids % and higher wet thickness require longer residence time and/or higher temperatures to achieve efficient drying, and alternatively, higher starting solids % and lower wet thickness typically reach the desired partial drying state with shorter residence times and/or lower temperatures. Furthermore, when drying on high surface-energy materials such as steel or other metals, the NCEs tend to strongly adhere to the surface. Release agents such as glycol ethers, mineral oil, silicone oils, and more can be used to help facilitate removal of the partially dried redispersible NCEs from the manufacturing equipment. Alternatively, a lower surface energy substrate or coating such as polytetrafluoroethylene (PTFE), polysilazanes, functionalized silicones, and other low energy organic polymers can be used to facilitate easy release from metal.

Combining a plurality of these thermal drying methods can be advantageous to decrease drying time and increase throughput. As an example, a thin sheet of a 4 wt % redispersible NCE solution can be deployed onto a PTFE belt that will first travel through a flotation dryer where heated air is directed at the sheet from multiple directions; then, once the sheet reaches a semi-solid state (e.g., 10-20% solids), it will proceed through a series of heated rollers where the sheet is in direct contact with the heated rollers or other conduction heating mechanisms to bring it to 30-60 wt % solids. As another example, certain dryer mechanisms can be selected for combined use with specific source solutions that are to undergo drying. Belt dryers (steel belt, convection, impingement, flotation, etc.) work well for very low solids solutions that are more liquid like and more vulnerable to direct heat applications, while thermoforming and heat rollers work best for material that is more solid like and has a lower concentration of water. In embodiments, each method can be employed sequentially at a selected time in the overall drying process to optimize drying, for example impingement belt drying followed by a heat press, or steel belt dryer with above impinged air followed by drying in a heated cylinder system.

Under certain circumstances, drying additives can be employed to expedite or facilitate drying For example, solvents with a lower heat of vaporization than water, such as acetone, ethanol, isopropyl, and the like, may be used in exchange of water to reduce drying time. Additives are desirably selected to maximize compatibility with the fibers' hydrophilic properties and with the nonpolar solvents already in the solution. To use such an additive, a solvent exchange step can be employed prior to thermal drying. Performing the solvent exchange can involve centrifuging the redispersible NCE solution to remove water then adding in the drying additive (such as ethanol), spreading the solution into a thin sheet and drying with an impingement dryer.

b. Mechanical Drying Methods

Partial drying may be achieved through the use of a variety of mechanical drying mechanisms including vacuum dewatering, centrifugal dewatering, mechanical pressing, and the like. During mechanical dewatering some of the redispersion additives will be lost in the white water due to their size and solubility. This differs from thermal drying where water is evaporated out, leaving behind all the solids in the starting solution. To adjust for the loss of additives in the white water, redispersion additives can be added in the initial solution at a higher loading so that the final product has the intended additive loading and is offset from the loss. For example, if 10 wt % of the additives are lost during the mechanical dewatering stage and the desired additive loading in the final sheet is 10 g, then 11.11 g additives can be added to the initial solution to target an end weight of 10 g in the final redispersible NCEs. In embodiments, retention aids, such as are familiar in the pulp and paper industry, can be used in small doses to avoid loss of the additives during the mechanical dewatering process. As examples, small quantities of biobased retention aids such as chitosan, cationic starch, cationic guar, cationic cellulose derivatives, alginates, and the like, can be employed.

If temperature-responsive polymers are selected as the redispersion aids, the slurry can be heated above the LCST to reduce additive loss with mechanical dewatering. Below the critical transition temperature, the temperature-responsive polymers have a strong affinity towards the water, resulting in the loss of additives upon water drainage. When heated above the transition temperature, the temperature-responsive polymers self-assemble in the surface of the NC elements and repel the water, so as water is drained from the solution the additives have a lower tendency to leave. A vacuum dewatering process can be used to partially dewater NCE-containing formulations to a desired moisture level through suction. A wet sheet is formed by pouring, dipping, or spreading the solution onto a porous medium and then pumps are used to create a pressure differential and draw out excess water. A thin profile of NCEs is ideal to minimize fiber-fiber interaction, but a thick enough layer must be formed or else there will be pores for air to escaper resulting in the inability to apply a high enough vacuum force.

A dewatering centrifuge or decanting centrifuge is a fast process that can be used to partially dewater NCE-containing formulations to a desired moisture level through centrifugal force. The decanting centrifuge works in a continuous process with a conical-shaped bowl that lifts solids from the liquids as they are being separated. The centrifugal force separates components based on density, removing the less dense component (water). When selecting this method, it is critical to select additives with similar densities to the selected nanocellulose element. For example, if a nanocellulose fiber has a density of 1.5-1.6 g/cm³, carboxymethyl cellulose that has a density of 1.6 g/cm³ can be used along with additives such as sorbitol, xylitol, trehalose, or mannitol, and/or other additives having a density in the same range. It is ideal to select additives with densities as close to the NCE density to avoid additive separation from the fibers. Heating above the critical transition temperature of the selected additives can reduce the likelihood of separation if the bonding process between NCEs and the redispersion additives has already been initiated. The redispersible NCE solution may be heated above the LCST prior to entering the centrifuge, the centrifuge itself may also be heated to raise the temperature of the solution to above the LCST, or a combination thereof.

Mechanical pressing can be used to partially dewater NCE-containing formulations to a desired moisture level by applying a force to the NCE-containing solution on a mesh like substrate. Examples of mechanical dewatering machines include a screw press, belt press, filter press, and the like. A fine mesh or porous material are ideal substrates for this process because the holes allow for areas of water to escape while eliminating fiber loss. Alternatively, the presence of a larger cavity or escape paths can be used, but the risk for fiber loss is greater. Advantageously, the NCE-containing formulation can be mechanically dewatered in sheet form to limit the amount of fiber-fiber interactions, for example using a method such as a belt press that uses rollers to apply mechanical pressure to a wet sheet to remove excess water, and thus allowing for a thin profile to be achieved.

c. Combined Methods

Partial drying may be achieved through a combination of the methods listed above. Multiple mechanical methods and/or multiple thermal methods can be employed, as described above. One or more mechanical and thermal processes may be used together, sequentially in either order or may be applied to the material at the same time. For example, a redispersible NCE solution of 0.5-10% can be dewatered via vacuum to ˜15-20 wt % solids then heat pressed to reach a solids content greater than 30 wt %. It can also be advantageous to combine multiple mechanical dewatering methods with thermal dewatering. For example, a redispersible NCE solution of 0.5-10% can be dewatered via vacuum to ˜15-20 wt % solids, then mechanically pressed to reach ˜20-30 wt % solids, then heat pressed to reach a solids content greater than 30 wt % solids.

Another example of method combination is mechanical dewatering a redispersible NCE solution of 0.5-10 wt % in sheet form either by vacuum or mechanical pressing (rollers) or both sequentially to 15-30 wt % solids and then thermally drying through a belt dyer to reach 40 wt % solids or above. Both the fourdrinier or high-speed cylinder machines used for papermaking can be used to produce partially dried redispersible NCEs through mechanical and thermal drying methods.

In embodiments, these familiar methods can be adapted to optimize partial drying processes for NFC-containing materials. For example, in embodiments, the standard procedure used for paper and carton board making can be adapted to handling the smaller fibers. In certain embodiments, a finer mesh may be required to avoid NCE loss during the pressing process. If a fourdrinier machine is selected for use in partial drying, the redispersible NCE solution can be deposited onto a moving wire where water starts drain due to gravity, hydraulic pressure gradients, vacuum systems, and the like or combinations thereof. In a high-speed cylinder machine, a wire-covered cylinder can be used to pick up NCE with the additives as the cylinder revolves. In embodiments, heating the redispersible NCE solution prior to sheet formation and mechanical drainage can help reduce additive loss. After the forming process the formed sheets move through a series of rollers that further mechanically dewater the redispersible NCE mat before it enters a series of cylinder dryers or a larger drum or yankee dryer. Unlike in traditional paper making where a fully dried material into ideal, the papermaking systems can require adaptations to produce a sample between 30-90 wt % solids. Decreasing the mechanical pressure applied by the rollers, decreasing the temperature in the drying section, speeding up the belt, and other process optimizations can be made to ensure that the final sheet is only partially, not fully, dried.

### EXAMPLES

Partially dried materials were produced from redispersible-NCE-containing formulations using the protocols outlined below. The solids content in the partially dried materials ranged from 20-70 wt % and additive loading from 0-30 wt % with respect to NCEs. All samples that were produced were then subjected to redispersion under low shear following the same conditions: 100 g solution containing 1 wt % fiber was mixed at 1000 rpm in a 500 mL beaker.

In all the following experiments the redispersible-NCE-containing formulations were all prepared the same way (unless stated otherwise), using a combination of a temperature-responsive polymer and a blocking agent as drying/dispersal additives in the following ratios:
38:1:1 NFC:Temperature-Responsive Polymer:Blocking Agent
18:1:1 NFC:Temperature-Responsive Polymer:Blocking Agent
8:1:1 NFC:Temperature-Responsive Polymer:Blocking Agent
   Where the temperature-responsive polymer was selected from the following: MC, HPMC, NaCMC, and where the blocking agent is selected from the following: Glycerol, xylitol, maltitol, mannitol, sorbitol, maltodextrin, PEG.

Other selections of temperature-responsive polymers in combination with selected blocking agents would also be available to use in formulations for testing in accordance with these procedures.

| Selected Temperature- | |
|---|---|
| Responsive Polymers | Selected Blocking Agent |
| MC | Polyol: Glycerol, Xylitol, Sorbitol or |
| | Maltitol |
| HPMC | Polyol: Glycerol, Xylitol, Sorbitol, or |
| | Maltitol |
| MC | Saccharide: Maltodextrin, sucrose, or |
| | fructose |
| HPMC | Saccharide: Maltodextrin, sucrose, or |
| | fructose |
| MC | PEG |
| HPMC | PEG |
| NaCMC | Polyol: Glycerol, Xylitol, or Maltitol |
| NaCMC | Saccharide: Maltodextrin, sucrose, or |
| | fructose |

Microfibrillated cellulose (MFCs) at 3 wt % fibers in water as received from the manufacturer was used to prepare all the samples used in the Examples. First, additives were prepared by solubilizing in the amount of water required to dilute the 3 wt % fibers down to 2 wt % fibers. The additive containing solution was then combined with the 3% MFC by mixing at 6,000 rpm with an Ultra Turrax for 15 minutes. Control samples were also diluted down to 2 wt % fibers. Deionized water was used to prepare all the samples. All samples were at 2 wt % fibers prior to drying.

After the materials were prepared, they were evaluated for redispersibility using both visual and rheological analysis. Visual analysis of the degree at which the material redispersed involved recognizing the extent to which a redispersible-NCE-containing sheet reconstituted in water. Three general degrees of redispersion were observed. Full redispersion occurred when the fibers completely unlocked from one another during the mixing process so that there were no remaining clumps present in the solution. In this case the properties of the NCEs were fully restored including viscosity. Partial redispersion occurred when the fibers partially unlocked from one another during the mixing process, but there were remaining clumps of undispersed fibers that had irreversibly agglomerated. In this case the properties of the NCEs were not fully restored, but viscosity could be restored to some degree. Poor redispersion occurred when there was minimal unlocking of fibers from one another, with many remaining clumps of undispersed fibers. In this case there was no restoration of NFC properties, and no restoration of viscosity.

### Example 1: Partial Dewatering Via Water Bath

300 mL of redispersible NCE-containing solutions prepared as described above were placed in 400 mL beakers and then placed in a water bath heated to 95° C. While heating, the redispersible-NCE-containing solution was heated by mixing with an overhead stirrer. The speed of the overhead stirrer was adjusted between 200-1500 rpm to achieve continuous mixing throughout the dewatering process. Lower rpm was used on the initial solution, but as the material dewatered and gained viscosity the mixing speed was adjusted to maintain constant flow. The redispersible NCE material exhibited very high viscosity when the solids level was between 5-25 wt % solids. As more water was removed and the solids level hit above 25 wt % the viscosity of the material decreased, and lower rpm was used. Visualization was used to assess when to stop the partial dewatering and a moisture analyzer was used to confirm the solids %. It took approximately 5 hours to reach a 30% crumb like material. The dewatering process speeds up significantly above the 25% solids level.

After all the samples were collected, the samples were redispersed under low shear conditions following the procedure shown above. As expected, the control samples did not regain full viscosity and contained many nondispersed clumps of fibers whereas the partially dried NCEs treated with 10 wt % and 20 wt % additives with respect to fibers achieved full dispersion and fiber unlocking under 5 minutes.

### Example 2: Partial Dewatering Via Hot Press

Two 2 mm rectangle molds placed on parchment paper were filled with 2% fiber redispersible NCE solutions and a spatula was used to create an even layer across the top of the mold. A second piece of parchment paper was placed on top, and the mold was inserted into a t-shirt press heated to 140° C. and pressed for 199 seconds. After the press was completed the remaining material from the two molds was combined into one mold that was placed between new parchment paper and pressed at 120° C. for 60 seconds. The mold was then removed, and a thin silicone mat outline was placed around the material, and it was pressed again at 120° C. for 60 seconds. The silicone outline was removed and the material continued to be pressed at 120° C. for 60 seconds until the desired solids % is achieved. This process yielded partially dried NCEs in a flake like form.

### Example 3: Partial Dewatering Via Water Bath and then Heat Press

The 2% redispersible NCE solution was first dried to ˜7-9 wt % solids via water bath following the procedure outlined in Experiment 1. Next, 2 mm rectangle molds were filled with the 7% material and a spatula was used to even out the material across the mold that was placed on top of parchment paper. A second piece of parchment paper was placed on top, and the mold was inserted into a t-shirt press heated to 140° C. and pressed for 199 seconds. The pressed sheet was removed from the 2 mm mold and placed on a new sheet of parchment with a 1 mm mold rectangle of the same dimensions and pressed at 120° C. for 90 seconds. The 1 mm mold was removed and the sheet continued to be pressed in intervals of 90 seconds at 120° C. until the desired solids % is achieved. This process yielded partially dried sheets.

### Example 4: Partial Dewatering Via Hot Plate

A redispersible-NCE-containing formulation was placed on either a silicone mat or thin aluminum tray and spread out to a 1.5 mm thickness using a doctor blade. The substrate with the thin layer of NCE was placed on a hot plate set to 80° C. and allowed to dewater to the desired solids %. This process was much harder to control since drying was observed to occur from the inside out and often started occurring rapidly once ˜20 wt % solids was achieved. It was found that places a mold outside the material or making the material thicker along the edges resulted in more uniform controlled drying.

### Example 5: Partial Dewatering Via Heat Lamp

The sample preparation was followed as used in Example 4. Redispersible NCE solution was spread into thin sheets on either a silicone mat or thin aluminum tray and placed below a hear lamp. The material was left to dry until the desire solids % was achieved.

### Example 6: Partial Dewatering Via Hot Plate and Heat Lamp

This Example is a combination of Examples 4 and 5. Material was cast into thin sheets and placed on a heat pad underneath a heat lamp where it was allowed to dry until the final solids % was achieved.

### Example 7: Partial Dewatering Via Microwave Dryer

A 2 wt %, 3 wt %, 4 wt %, 5 wt %, 6 wt %, and 8 wt % fiber redispersible microfibrillated cellulose solution was prepared from a 10 wt % fibers in water as received from the manufacturer. First, additives were prepared by solubilizing in the amount of water required to dilute to 10 wt % fibers down to the corresponding wt %. The additives containing solution was then combined with the 10 wt % MFC by mixing at 10,000 rpm with an Ultra Turrax for 15 minutes. It would be more ideal to use a higher shear mixer with the higher solids level, such as a triple shaft mixer. Some solutions were prepared following Example 1 and stopping the drying process in the water bath once the desired solids content was reached, this method can help create a more homogenous solution. Samples were formed into rectangular sheets on to a silicone mat by either using a rolling pin with a set thickness or filling a 2 mm mold and using a spatula to create an even layer, the mold was removed prior to drying. Samples were run through an 800 mm rigid waveguide microwave dryer system at 0.6 kW and the heated air system set to 120° C. The belt speed was varied from 20 in/min to 60 in/min and multiple passes were required to achieve partially dried samples. A 4×4 inch sample of 8% solids prepared via Example 1 and spread with a rolling pin at 2 mm reached 32 wt % solids with 5 passes through the dryer at 40 in/min. A 6×6 inch of 8% solids prepared via Example 1 and spread with a rolling pin at 2 mm sample reached 42 wt % solids with 4 passes through the dryer at 20 in/min. Larger samples with more uniform wet thickness dried more uniformly and it was found that flipping and rotating between passes resulted in more uniform drying as well. Higher microwave power, 1-2 kW was trialed as well, although it often resulted in “popping” of material during the drying process forming defects, nits, and burnt regions. Drying the higher solids materials required fewer passes than the lower solids solutions at the same conditions. A minimum of 4 wt % solids appeared to be ideal for achieving a uniformly dry sheet with minimal defects.

Modifications to the process can be envisioned to achieve more uniform sheets. A continuous process with a roller or slot die can be set up at the start of the belt. An equal amount of material can be maintained in the microwave chamber to ensure that microwaves are being absorbed throughout the sheet. As another option, the conveyor part of the system can be eliminated or modified, with the batch sheet being held inside the microwave for varying amounts of time, for example from between about 1 and about 15 minutes.

### Example 8: Partial Dewatering Via Drum Dryer

An experiment can be conducted as follows to evaluate partial drying via a drum dryer.
Prepare a 1 wt %, 1.5 wt %, 2 wt %, and 2.5 wt % fibers in water redispersible MFC solution from 3 wt % as received MFC.
Prepare a 4 wt %, 5 wt %, and 6 wt % fibers in water redispersible MFC solution following the same sample preparation in Example 7.
Heat the drum dryer to the desired temperature, 80-120° C. and turn the drum rotor on.
Fill the feed tray with the redispersible MFC solution and turn the roller on to feed the solution from the tray on to the drum.
Adjust the drum speed so that the redispersible MFC sheet reaches a 40 wt % solids content by the time it rounds the drum.
Use a scraper or blade to lift material up off the drum and pull the sheet off onto the sheet roller. Increase the residence time or increase the temperature to increase the drying rate so that the MFC sheet reaches a 60 wt % solids content by the time it rounds the drum.
Decrease the residence time or decrease the temperature for the higher starting solids solutions, avoid overdying. Switch to a gravity or dip feeder if necessary.

Unless otherwise indicated, all numbers expressing reaction conditions, quantities, amounts, ranges and so forth, as used in this specification and the claims are to be understood as being modified in all instances by the term “about.” Accordingly, unless indicated to the contrary, the numerical parameters set forth herein are approximations that can vary depending upon the desired properties sought to be obtained by the present invention.

While this invention has been particularly shown and described with references to preferred embodiments thereof, it will be understood by those skilled in the art that various changes in form and details may be made therein without departing from the scope of the invention encompassed by the appended claims.

1. A method of preparing a solid or semisolid material comprising nanocellulose (NC) elements, wherein the solid or semisolid material retains at least about 5 wt % water, comprising:
providing a liquid formulation comprising a suspension of nanocellulose (NC) elements in a liquid medium, and at least one drying/dispersal additive, wherein the drying/dispersal additive is selected from the group consisting of temperature-responsive polymers, small molecule additives in volatile systems, and blocking agents; and
partially drying the liquid formulation, thereby producing the solid or semisolid material.

2. The method of claim 1, wherein the solid or semisolid material retains an amount of water between a lower limit of about 5 wt % water and an upper limit of about 10 wt % water.

3. The method of claim 1, wherein the solid or semisolid material retains an amount of water between the lower limit of about 40 wt % and the upper limit of about 70 wt % water.

4. The method of claim 1, wherein the NC elements comprise cellulose nanofibers or cellulose microfibers.

5. The method of claim 1, wherein the at least one drying/dispersal additive is a temperature-responsive polymer.

6. The method of claim 5, wherein the temperature-responsive polymer is a lower critical solution temperature (LCST) polymer or a short-chain oligomer derived from a LCST polymer.

7. The method of claim 6, wherein the LCST polymer is selected from the group consisting of methyl cellulose, carboxymethyl cellulose, sodium carboxymethyl cellulose, hydroxylethyl cellulose, hydroxypropyl cellulose, hydroxypropylmethyl cellulose, ethylhydroxyethyl cellulose, polyvinylcaprolactam, poly(methyl vinyl ether), poly(N-isopropylacrylamide), poly(N,N-diethylacrylamide), poly(ethylene oxide) and poly(propylene oxide) block copolymer, and elastin poly(pentapeptide).

8. The method of claim 6, wherein the liquid formulation further comprises a second drying/dispersal additive selected from the group consisting of temperature-responsive polymers, small molecule additives in volatile systems, and blocking agents.

9. The method of claim 8, wherein the second drying/dispersal additive is a blocking agent.

10. The method of claim 9, wherein the second drying/dispersal additive is xylitol or sorbitol.

11. The method of claim 10, wherein the LCST polymer is HPMC.

12. The method of claim 11, wherein the NC elements comprise cellulose nanofibers, and a ratio of the cellulose nanofibers, the HPMC and the xylitol or sorbitol falls within a range from about 38:1:1 NFC:HPMC:(xylitol or sorbitol) to about 8:1:1 NFC:HPMC:(xylitol or sorbitol).

13. The method of claim 1, wherein the drying/dispersal additive is a small molecule additive in a volatile system.

14. The method of claim 1, wherein the drying/dispersal additive is a blocking agent.

15. The method of claim 14, wherein the blocking agent is a humectant.

16. The method of claim 14, wherein the blocking agent comprises pulp fibers.

17. The method of claim 1, wherein the step of partial drying comprises heating the liquid formulation to a maximum temperature of less than 150° C.

18. The method of claim 17, wherein the step of partial drying comprises heating the liquid formulation to the maximum temperature between about 60° C. and about 140° C.

19. The method of claim 1, wherein the step of partial drying comprises heating the liquid formulation to the maximum temperature between about 140° C. and about 250° C.

20. The method of claim 1, wherein the step of partial drying comprises a thermal drying method selected from the group consisting of heat pressing, continuous belt drying, drum drying, batch drying in an oven, use of a heated mix chamber, and cylinder drying.

21. The method of claim 20, wherein the step of partial drying comprises a substep of spreading the liquid formulation in a thin sheet and exposing the thin sheet to heat on one or both sides.

22. The method of claim 1, wherein the step of partial drying comprises a mechanical drying method selected from the group of vacuum dewatering, centrifugal dewatering, and mechanical pressing.

23. The method of claim 1, wherein the step of partial drying comprises a substep of spreading the liquid formulation in a thin sheet and exposing the thin sheet to heat on one or both sides.

24. A solid or semi-solid material comprising a population of redispersible NC elements embedded within the material in a preselected concentration and comprising an amount at least one drying/dispersal additive;
wherein the solid or semi-solid material has a water content of at least about 5 wt %, and wherein the redispersibility of the solid or semi-solid material is greater than the redispersibility of a control solid material having a water content of less than about 5 wt %, and
wherein the control solid material comprises the same population of redispersible NC elements and the same amount of the at least one drying/dispersal additive as the solid or semi-solid material.

25. The solid or semi-solid material of claim 24, wherein the solid or semi-solid material has a water content of at least between 5 wt % and 10 wt %, and the control solid material has a control water content less than the water content of the solid or semi-solid material.

26. The solid or semi-solid material of claim 24, wherein the redispersible NC elements comprise at least one of nanofibrillated cellulose and microfibrillated cellulose.

27. The solid or semi-solid material of claim 24, wherein the material is formed as a sheet.
